(19) United States
(12) Patent Application Publication
(10) Pub. No.: US 2014/0069928 A1
(43) Pub. Date: Mar. 13, 2014

(54) APPARATUS AND METHODS FOR CONTAINER LINER

(71) Applicant: Wei Weng, Sayville, NY (US)

(72) Inventor: Wei Weng, Sayville, NY (US)

(21) Appl. No.: 13/615,508

(22) Filed: Sep. 13, 2012

(51) Int. Cl. B65D 25/14; B31B 1/62

(52) U.S. Cl. 220/495.01; 493/150

(57) ABSTRACT

A container liner that generally matches the size of a container, adapts generally to the shape of the container upon insertion into the container, and forms a substantially waterproof barrier in order to keep the contents of the container from soiling the container. The container liner is formed from a substrate and a substantially waterproof coating. The substrate has a bottom panel, a plurality of side panels, and a plurality of substrate-wedge panels. The substantially waterproof coating adheres to the substrate panels and creates a plurality of waterproof-coating-wedge panels between each substrate-wedge panel and adjacent side panel. Included is a method of providing the container liner and a method of assembling the container liner.

### TECHNICAL FIELD

The present invention relates to container liners in general and particularly relates to container liners that are waterproof and that have a stacking configuration and assume a container-shaped configuration during use.

### BACKGROUND OF THE INVENTION

There are many environments where a container is cleaned and reused on a frequent basis. For example, more than 30 million laboratory mice and rats are housed in rodent cages. The mouse cages need to be changed at least every five days, sometimes two times a week. This puts a burden on animal welfare workers because all the cages need to be cleaned and washed, requiring special washing machines that typically only hold a limited number of cages during each washing. This requires many loadings, washing cycles and un-loadings per day. Also this washing procedure is not always consistent, for example, detergents are introduced during the washing and may not be completely removed during the rinse process. The remaining detergent has scent that may change the behavior of mice.

In addition, many containers used for various purposes require sterilization, for example: spas where a water bucket is used for soaking feet; medical offices where containers hold infectious waste products; lunch boxes that frequently hold drinks; and RV or camping sites where running water may not be easily accessible. Similarly, mouse cages need to be sterilized so that diseases are not spread between the mice. In order to accomplish this, the cages are typically put in an autoclave. An autoclave procedure has additional problems: it requires a large working space in the lab, it has a long timeline because the small internal space inside autoclave requires workers to load and reload many times per day, it uses a very high energy expenditure, and sometimes the cages are too hot after the autoclave procedure causing the death of the mice. It is therefore desirable to provide a container for these purposes that is safer and more efficient.

### SUMMARY OF THE INVENTION

The present invention includes a container liner that generally matches the size of a container, adapts generally to the shape of the container upon insertion into the container, and forms a substantially waterproof barrier in order to keep the contents of the container from soiling the container. The present invention also includes a method of providing the container liner and a method of assembling the container liner. The container liner is formed from a substrate and a substantially waterproof coating. The substrate has a bottom panel with a plurality of bottom panel edges, a plurality of side panels with side panel edges, and a plurality of substrate-wedge panels with a pair of wedge panel edges emanating from a common point. The side panels are foldably connected to each of the bottom panel edges and for each of the plurality of substrate-wedge panels; one of the wedge panel edges is foldably connected to one of the side panel edges. The substantially waterproof coating is adhered to the bottom panel, side panels, and substrate-wedge panels, and also creates a plurality of waterproof-coating-wedge panels between each substrate-wedge panel and adjacent side panel. The intended use of the container liner is to provide a waterproof barrier, however, the present invention container liner may also be useful in situations where an absolute waterproof barrier is not necessary. Therefore, the term substantially waterproof means both absolute waterproof and mostly waterproof, i.e. coatings where a few small holes are created in the waterproof coating or where the coating has some leakage over a period of hours or days. It should be understood that term waterproof as used in this disclosure means substantially waterproof.

In addition, the container liner may assume a stacking configuration, which may be flat or generally flat, prior to use to allow large quantities to be packed in a small volume. This is advantageous for lining container that need to be cleaned on a regular basis, for example containers that hold small animals. The container liner can be easily inserted into the container and when taken out of the container, it will go back to the flat form for easy disposal. However, the container liner may also be reusable depending on the material used for the substrate and the waterproof coating. In the disposable embodiment the substrate may be formed from paper or a degradable plastic; while in the reusable embodiment the substrate may be formed from a more durable plastic. Liners formed from paper will be more environmental friendly for disposal or re-cycle. The substantially waterproof coating may also be formed from degradable plastics. The substantially waterproof coating may be a thin plastic film adhered to the substrate by spraying adhesive on the substrate components to form a bond between the substrate components and the film of waterproof material. A process similar to conventional magazine cover printing may also form the substantially waterproof coating. For situations where a sanitary barrier is need, the container liners may be sterilized using a centralized sterilization process that uses gamma rays or high power electric rays.

As the container liner is inserted into the container, the bottom panel meets the base of the container, the side panels are folded up and sit against the side walls of the container, and the substrate-wedge panels and the waterproof-coating-wedge panels are pulled behind the side panels so that the side panels meet at the corners. The waterproof-coating-wedge panels are substantially the same size as the substrate-wedge panels to allow the waterproof-coating-wedge panels to be pulled between the substrate-wedge panel and the adjacent side panel when the wedge panels are pulled behind the side panels. The waterproof-coating-wedge panels located between each substrate-wedge panel and adjacent side panels allow the waterproof barrier to be maintained when the container liner is folded from the flat (or generally flat) configuration into the container shape. The closer in size the waterproof-coating-wedge panels are to the substrate-wedge panels the more flatly and fully the waterproof-coating-wedge panels may be pulled between the substrate-wedge panel and the adjacent side panel when the liner is inserted into the container. Having the side panels meet cleanly is useful in containers that hold small animals because the animals will not be able to chew the waterproof-coating-wedge panels. However, the present invention container liner may also be useful in situations where the substrate side panels do not meet perfectly or where the waterproof-coating-wedge panel can be seen. Therefore, the phrase substantially the same size means both exactly the same size and close to the same size.

In one embodiment of the present invention, the side panels have cutouts and the waterproof coating forms a substantially waterproof window covering the cutouts. In another embodiment of the present invention, a foldable substrate structure, which assumes a generally flat configuration prior to use and a generally open-enclosure-shaped configuration upon insertion into the container, is included. The foldable substrate structure has a top panel with top panel edges; structure-side panels foldably connected to one of the top panel edges; and mounting tabs foldably connected to each of the structure-side panels. The mounting tabs adhered to the bottom panel to hold the foldable substrate structure in place. The foldable substrate structure may be a housing for the animals housed in the container liner.

### BRIEF DESCRIPTION OF THE DRAWINGS

FIG. 1 is a perspective view of the container liner fully inserted into a container, showing panels folded into position;

FIG. 2 is a top view of one embodiment of the present invention, showing panels and fold lines; assembled;

FIG. 3 is an exploded view of the container liner substrate, waterproof coating, and mouse housing in alignment;

FIG. 4 is a perspective view of the container liner is it is folded into the shape of a container;

FIG. 5 is a cutaway view of the container liner fully inserted into the container with a mouse residing therein;

FIG. 6 is a detailed top view of one embodiment of the present invention, showing windows and animal housing;

FIG. 7 is a top view of another embodiment of the present invention;

FIG. 8 is a top view of another embodiment of the present invention;

FIG. 9 is a top view of another embodiment of the present invention.

### DETAILED DESCRIPTION

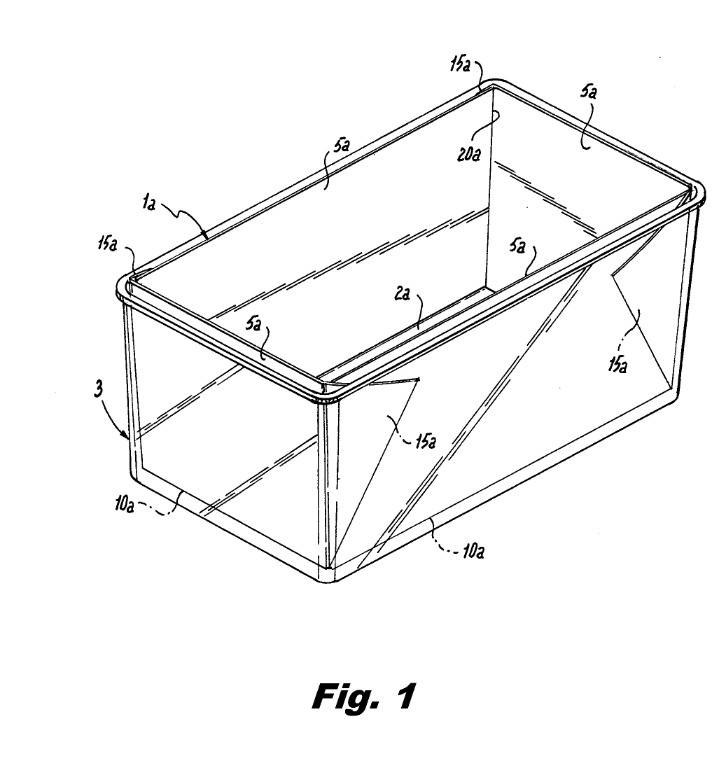

Before the present invention is described, it is to be understood that this disclosure is not limited to the particular embodiments described, as these may vary. The container liner of the present invention is described having a number of different embodiments; each having different shapes but similar components. Similar components are labeled with the same numbers but each shape will be labeled with different letters (i.e. base in rectangle is labeled 2a, base in first shaped pentagon is labeled 2b, base in second shaped pentagon is labeled 2c, and base in hexagon is labeled 2d). However, the present invention is not limited to the depicted shapes. It is to be understood that the present invention can be adapted to any shape. It is also to be understood that the terminology used in the description is for the purposes of describing the particular versions or embodiments only, and is not intended to limit the scope. Referring to FIG. 1, the present invention includes a container liner la that generally matches the size of a container,adapts generally to the shape of a container 3 upon insertion into the container 3, and forms a substantially waterproof barrier in order to keep the contents of the container from soiling the container 3.

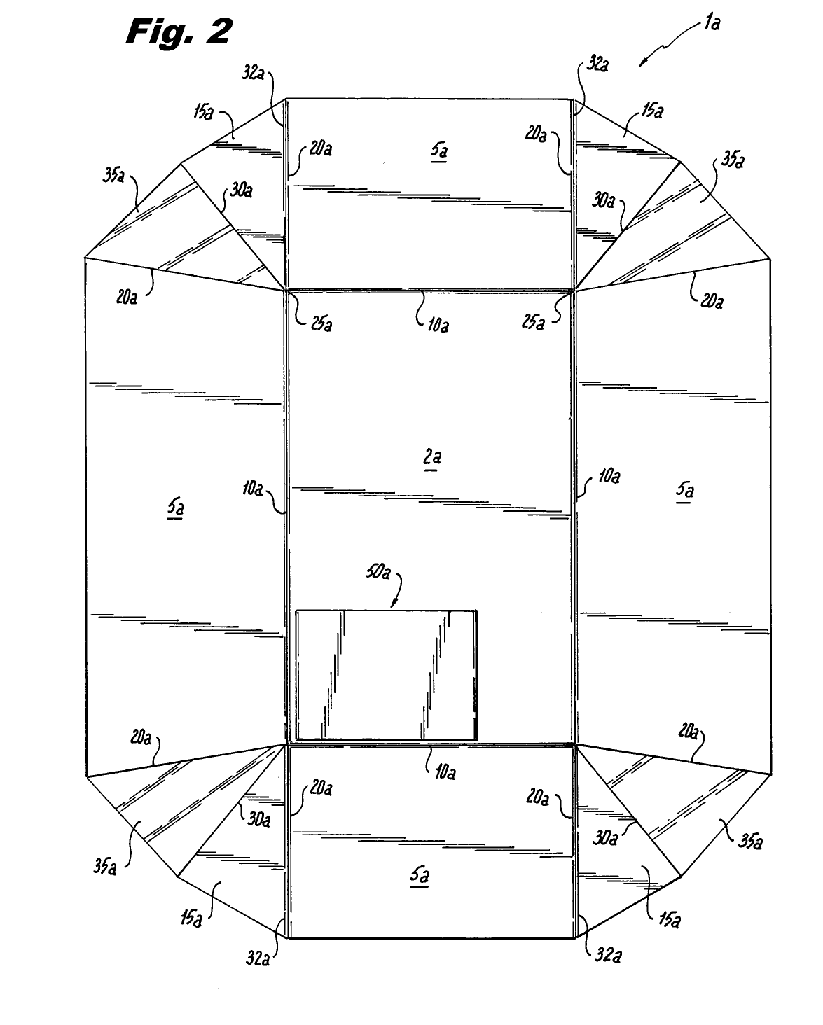

As shown in FIG. 2, prior to use, the container liner la may assume a stacking configuration, which may be flat or generally flat, to allow large quantities to be packed in a small volume. This is advantageous for lining containers 3 that need to be cleaned on a regular basis, for example containers 3 that hold small animals, such as mice, in a testing laboratory. In these facilities, the workers can take a flat container liner la from its packaging and place it into the container 3 in less than 5 seconds in order to create a clean environment for the animals. After a few days of housing, workers can take the container liner la out of the container 3 and the container liner la will go back to its flat form for easy disposal. The container liner la is formed from a substrate that has a bottom panel 2a with a plurality of bottom panel edges 10a, a plurality of side panels 5a foldably connected to each of the bottom panel edges 10a, and a plurality of substrate-wedge panels 15a with a pair of wedge panel edges 30a and 32a emanating from a common point 25a. The side panels 5a having side panel edges 20a and for each of the plurality of substrate-wedge panels 15a, one of the wedge panel edges 32a is foldably connected to one of the side panel edges 20a.

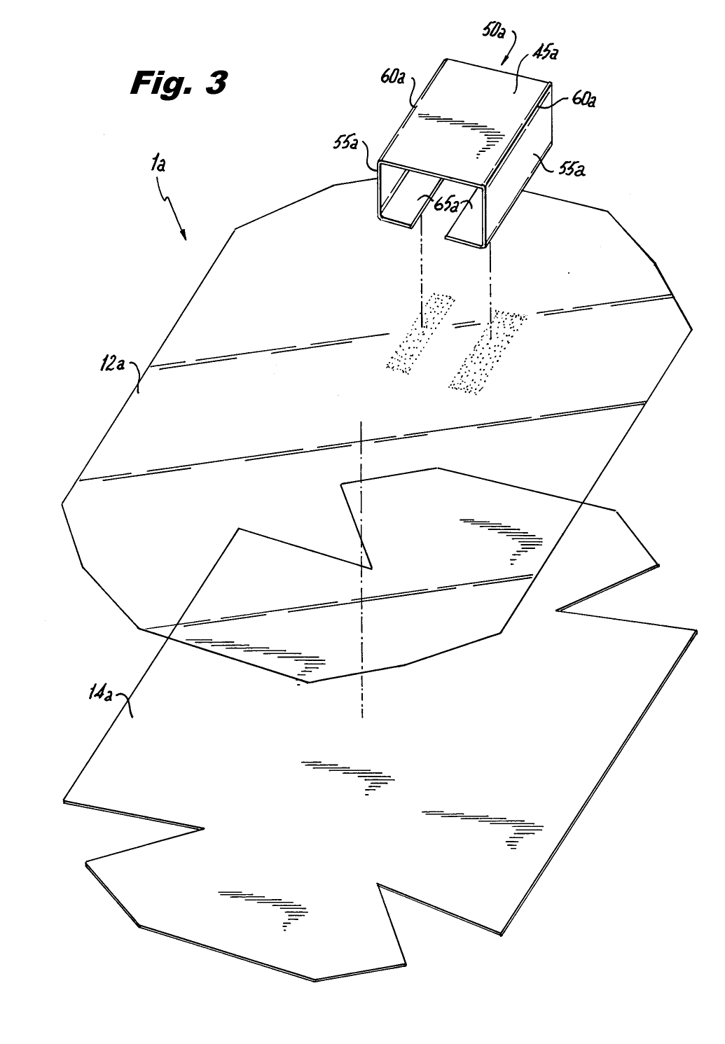

Referring to FIG. 3, the bottom panel 2a, side panels 5a, and substrate-wedge panels 15a may be formed from a single substrate piece 14a. The single substrate piece 14a may be cut and compressed (or folded, or bent, or any other reasonable means to create a fold line), at fold lines at panel edges 10a and 32a (shown in FIG. 2), to match the size and shape of a container. The substrate 14a may be formed of flexible but sturdy sheet material, such as paper, plastic, or biodegradable plastic, that can easily bend at the fold lines to create the bottom panel 2a, side panels 5a, and substrate-wedge panels 15a. The container liner 1 may be reusable if more durable plastics are used. A reusable container liner 1 may be sterilized by an autoclave. However, container liners 1 formed from paper or biodegradable materials will be more environmental friendly for disposal and re-cycling. The biodegradable material used may be for example: a polyester, a polyethylene, a polypropylene, organic cellophne, fluoropolymers, polyimide, polyetheretherketone, polyetherketoneketone, acetal, polyester, polyhydroxyalkanoates, polylactic acid, polybutylene succinate, polycaprolactone, polyanhydrides, polyvinyl alcohol, starch derivatives, and/or cellulose esters.

The side panels 5a may be generally rectangular or square in shape, but this is not a requirement. The top portion of the container 3 may be curved or have a particular shape causing the side panels 5a to be similarly shaped on the top edge opposite the foldable connection on the bottom panel edges 10a. In addition, the side panels 5a may be shorter or longer than the height of the container 3. It should be noted that the substrate-wedge panels 15a may be foldably attached to either of the side panels 5a that it is between to achieve the desired functionality. In addition, although the substrate piece 14a is shown as a symmetrical shape with two substrate-wedge panels 15a foldable connected to opposite side panels 5a, this is not necessary. Each substrate-wedge panel 15a may be foldably connected to a different side panel 5a, or there may be any combination of foldable connections to achieve the desired functionality, as will now be described.

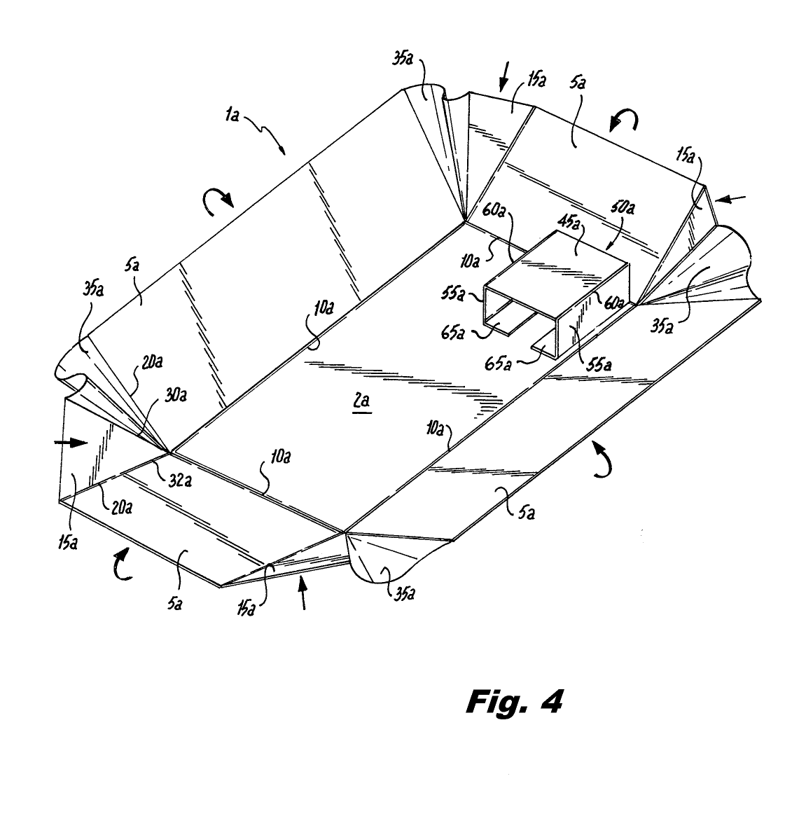

As can be seen in FIG. 4, when the single substrate piece 14a is folded at the fold lines at panel edges 10a and 32a, the bottom panel 2a, the side panels 5a, and the substrate-wedge panels 15a are created. When the container liner la is inserted into the container 3, the bottom panel 2a is placed against the bottom of the container 3, the side panels 5a are placed against the side of the container 3, and the substrate-wedge panels 15a are folded behind the side panels 5a, as shown in FIG. 1. Although the substrate-wedge panels 15a are shown as triangular shaped with the top of the substrate-wedge panels 15a being straight, the substrate-wedge panels 15a may also be pie shaped with the top of substrate-wedge panels 15a being rounded instead of straight. Similarly, the top of substrate-wedge panels 15a may be any shape that allows the substrate wedge panel 15a is to enclose the seam between adjacent side panels 5a when the container liner la is inserted into the container 3.

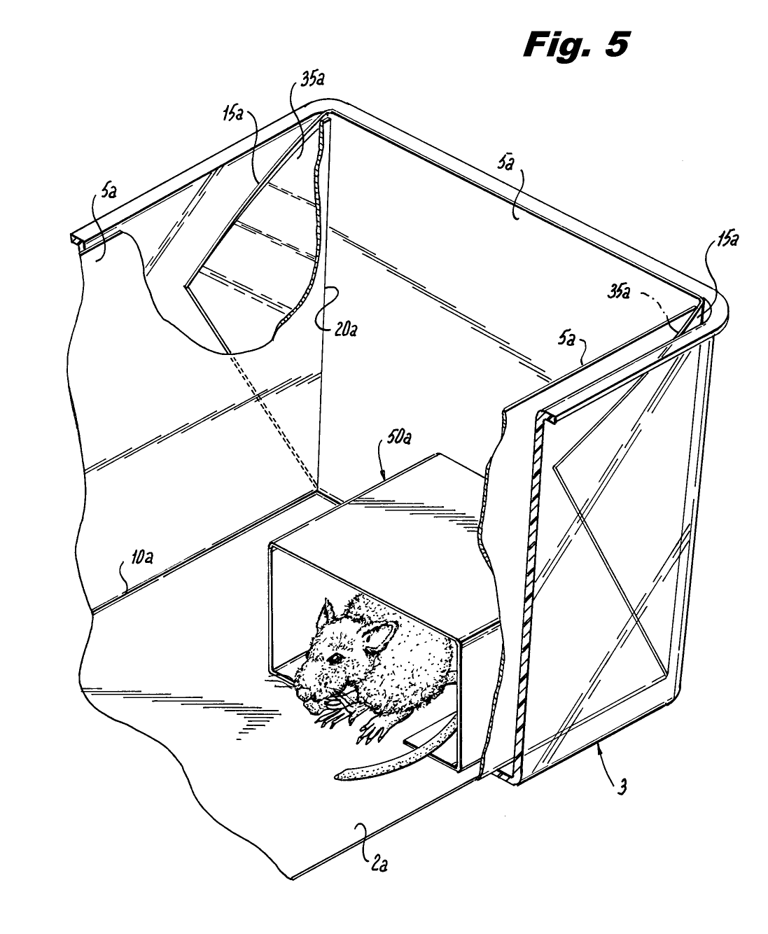

The container liner la of the present invention is substantially waterproof. Generally, foldable structures tend to leak from the corners where the side panels 5a meet because there is a discontinuity between the side panels 5a that allows the structure to lie flat (or generally flat). Referring to FIG. 3, in order to create a waterproof barrier, in one embodiment, the substrate 14a is covered with a sheet of waterproof material 12a, such as a thin plastic film, which may be aligned with the substrate 14a or cut to the size of the substrate 14a. When the waterproof material 12a is adhered to the bottom panel 2a, the plurality of side panels 5a, and the plurality of substrate-wedge panels 15a, the substantially waterproof coating 12a forms a plurality of waterproof-coating-wedge panels 35a between each of the substrate-wedge panel 15a and adjacent side panel 5a. As shown in FIG. 5, when the waterproof-coating-wedge panels 35a are substantially the same size as the substrate-wedge panels 15a, the substrate-wedge panels 15a pull the waterproof-coating-wedge panel 35a between the substrate-wedge panel 15a and the adjacent side panel 5a when the liner la is inserted into the container 3. The term substantially waterproof means both absolute waterproof and mostly waterproof, i.e. coatings where a few small holes are created in the waterproof coating (or substrate or film) 12a or where the waterproof coating 12a has some leakage over a period of hours or days. The waterproof coating 12a may also be formed from degradable plastics. Adhering the waterproof coating 12a to the substrate 14a may be accomplished by spraying adhesive on the substrate 14a that forms a bond between the substrate 14a and the waterproof material 12a when the waterproof material 12a is placed on the substrate 14a. The waterproof coating 12a may be adhered to the substrate 14a by a process similar to conventional magazine cover printing. Alternatively, the waterproof coating 12a may be sprayed onto the substrate 14a. There may be multiple coatings of the spray to build up the thickness of the waterproof coating 12a. The thickness of the waterproof coating 12a may vary in different areas. For example, the waterproof-coating-wedge panels 35a may not be as thick as the waterproof coating 12a over the bottom panel 2a. The spraying may be accomplished by placing the substrate 14a on a non-sticking surface to create the waterproof-coating-wedge panels 35a.

In an alternative embodiment, the bottom panel 2a, side panels 5a, substrate-wedge panels 15a and waterproof-coating-wedge panels 35a are formed from a single substrate; without the need for a separate sheet of waterproof material 12a. In this embodiment, the material used for the substrate is substantially waterproof, capable of providing the structure of the side panels 5a, capable of being compressed at fold lines at panel edges 10a and 32a, and thin enough to form waterproof-coating-wedge panels 35a that lay flatly behind the side panels. Alternatively injection molding or deferential spraying may be used to create a single substrate 14a with different thicknesses in the desired areas.

In embodiments where the container liner 1 has a sanitary barrier, the waterproof coating 12a may need to be impermeable and the sanitary barrier may be accomplished by sterilizing the container liners 1 with a centralized sterilization process such as gamma ray or high power electric ray during the manufacture process. On the other hand, in applications where the container liner la is holding small particles rather than liquids, the waterproof coating 12a may be more pervious and still provide a barrier for the container 3.

In another embodiment of the present invention, a foldable substrate structure 50a, which assumes a generally flat configuration prior to insertion into the container 3 and a generally open-enclosure-shaped configuration upon insertion into the container 3, is an additional feature of the container liner 1. As shown in FIG. 3, the foldable substrate structure 50a has a top panel 45a with top panel edges 60a; structure-side panels 55a foldably connected to one of the top panel edges 60a; and mounting tabs 65a, foldably connected to each of the structure-side panels 55a. The mounting tabs 65a adhered to the bottom panel 2a to hold the foldable substrate structure 50a in place. The foldable substrate structure 50a may be a housing enclosure for the animals housed in the container liner, as shown in FIG. 5. The foldable substrate structure 50a may have the structure-side panel 55a closest to the side panel 5a connected to the side panel 5a so that when the container liner 1a is inserted into the container 3 the foldable substrate structure 50a may open up to create the housing enclosure for the animals.

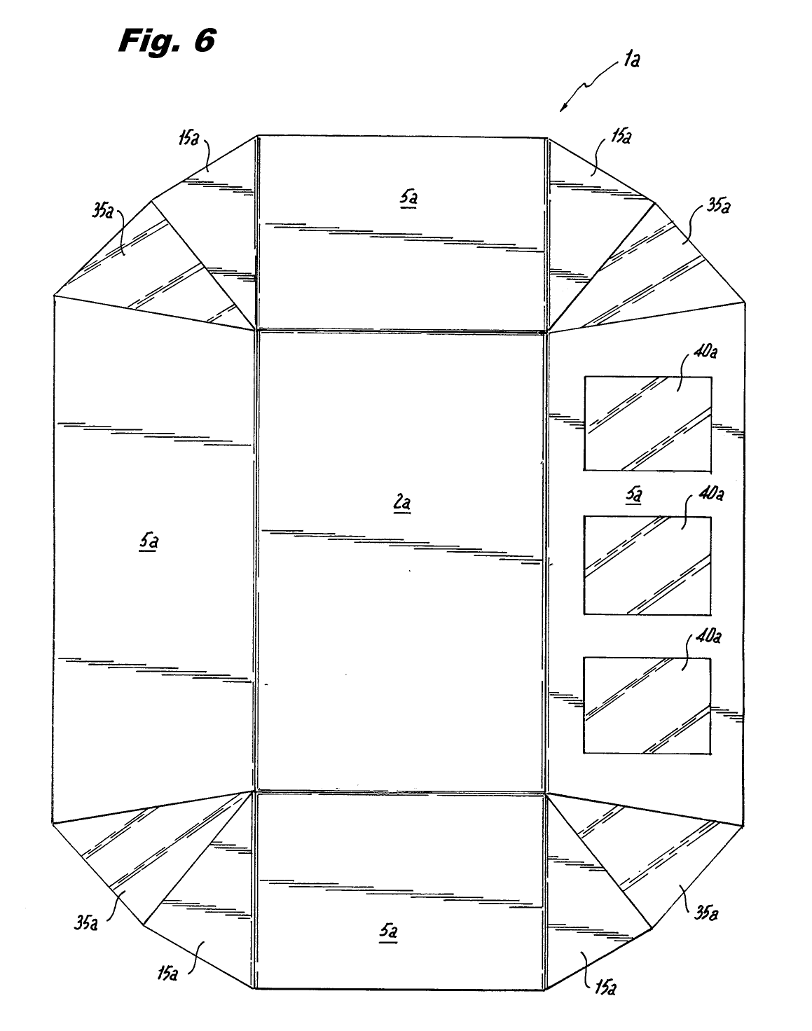

Referring to FIG. 6, in one embodiment of the present invention, the side panels 5a have cutouts 40a and the waterproof coating forms a substantially waterproof window covering the cutouts 40a. It should be noted that the number, size, and placement of the windows cutouts 40a may vary and still be within the scope of the invention.

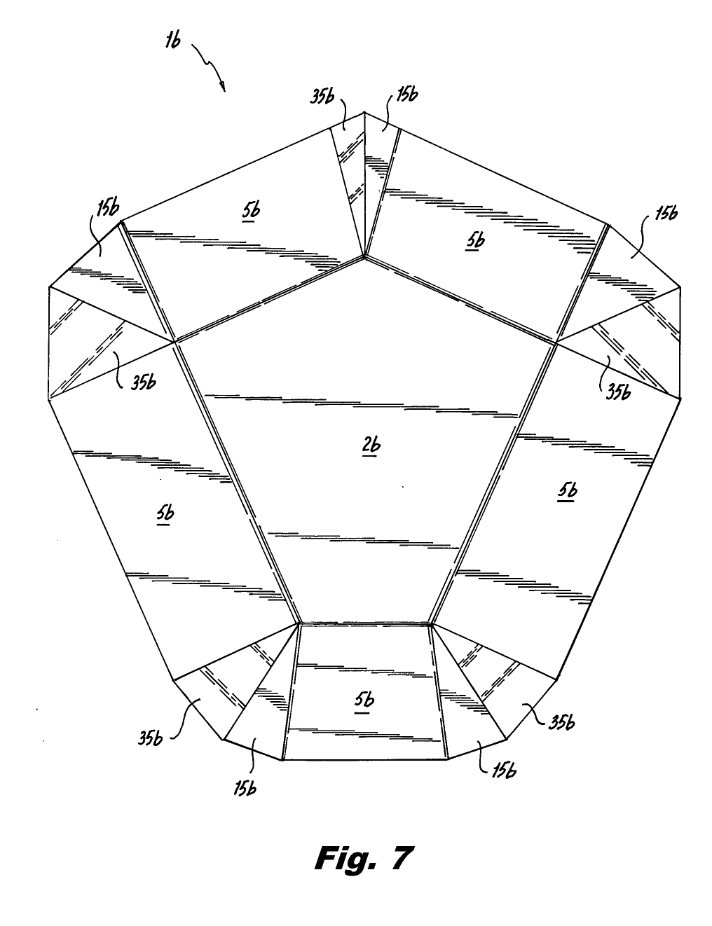

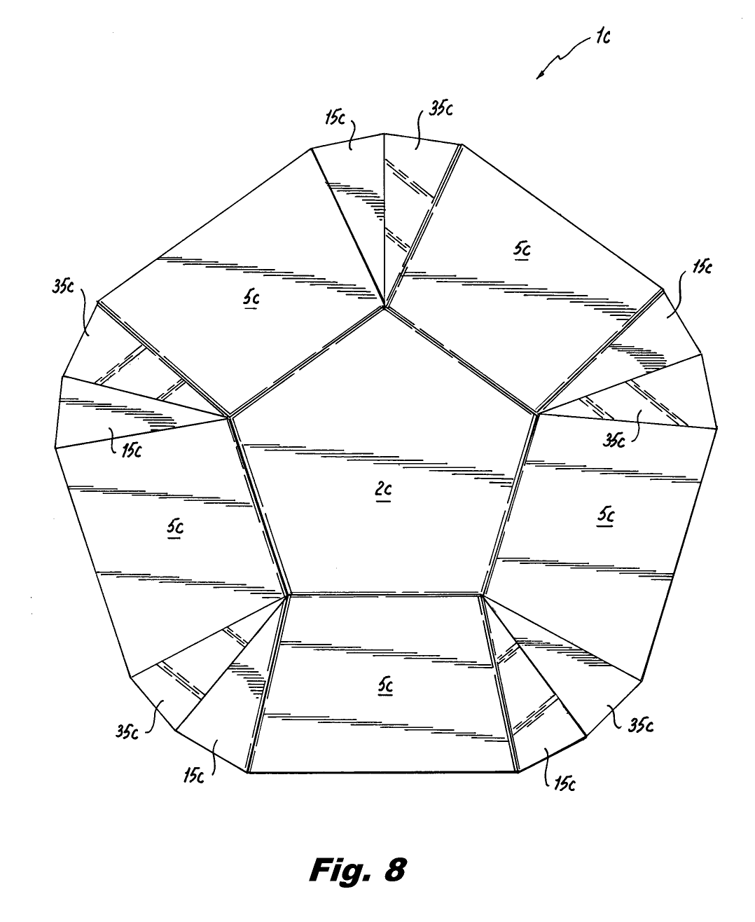

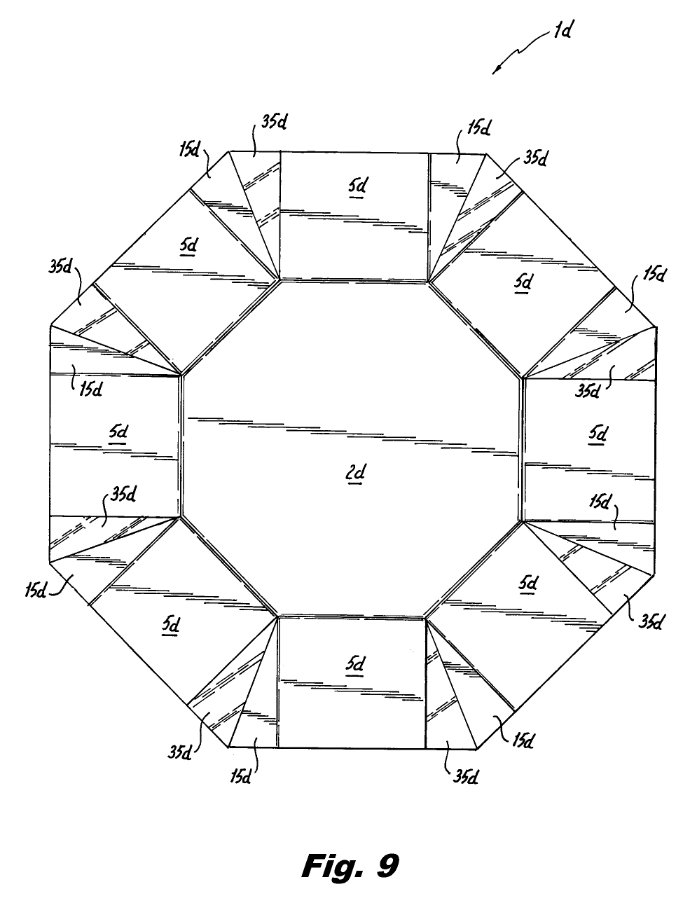

Shown in FIG. 7 is another embodiment of the container liner 1b having five sides 5b. The base 2b is shaped to fit into circular mouse rack that holds multiple pie shaped container 3 (cage). The substrate-wedge panels 15b and waterproof-coating-wedge panels 35b are similarly formed as described in the prior embodiments. Shown in FIG. 8 is another embodiment of the container liner 1c having five equal sides 5c. The base 2c is shaped to fit into a pentagon shaped container. The substrate-wedge panels 15c and waterproof-coating-wedge panels 35c are similarly formed as described in the prior embodiments. Shown in FIG. 9 is another embodiment of the container liner 1d having eight equal sides 5d. The base 2d is shaped to fit into a octagonal shaped container. The substrate-wedge panels 15d and waterproof-coating-wedge panels 35d are similarly formed as described in the prior embodiments.

Another aspect of the present invention is a method of providing a substantially waterproof container liner 1a (may also be b, c, d or any shape) adapted to a generally container-shaped configuration upon insertion into a container 3. The method includes providing a substrate 14a having a bottom panel 2a, a plurality of side panels 5a, and a plurality of substrate-wedge panels 15a, as described above in the description of the container liner 1a; and adhering a substantially waterproof coating 12a to the bottom panel 2a, the plurality of side panels 5a, and the plurality of substrate-wedge panels 15a, the substantially waterproof coating 12a forming a plurality of waterproof-coating-wedge panels 35a between each of the substrate-wedge panel 15a and adjacent side panel 5a, wherein the waterproof-coating-wedge panels 35a are substantially the same size as the substrate-wedge panels 15a allowing the substrate-wedge panel 15a to pull the waterproof-coating-wedge panel 35a between the substrate-wedge panel 15a and the adjacent side panel 5a when the liner la is inserted into the container 3.

Another aspect of the present invention is a method of assembling the container liner la (may also be b, c, d or any shape). The method includes two steps: (a) providing the substantially waterproof container liner la described above, and (b) foldably inserting the substantially waterproof container liner la into the container 3 of substantially the same shape and size as the container-shaped configuration of the substantially waterproof container liner la and allowing the substrate-wedge panel 15a to pull the waterproof-coating-wedge panel 35a between the substrate-wedge panel 15a and adjacent side panel 5a.

Although the preferred embodiments of the invention have been described above by way of example only, it will be understood by those skilled in the art that modifications may be made to the disclosed embodiments without departing from the scope of the invention. For example, the base 2 and side panels 5 may take on any shape or size and likewise, the wedge panels 15 and 35 may have a pie shape rather than a triangular shape. In addition, there may be only one window 40 or there may be windows 40 on all sides 5 of the container liner 1. Furthermore, various embodiments described herein or portions thereof can be combined without departing from the present invention. For example, the container liner 1 may have a mouse housing structure 50 but no windows 40.

I) claims:

1. A substantially waterproof container liner adapted to a generally container-shaped configuration upon insertion into a container, comprising:
a substrate comprising:
a bottom panel with a plurality of bottom panel edges;
a plurality of side panels foldably connected to each of the bottom panel edges, the side panels having side panel edges; and
a plurality of substrate-wedge panels with a pair of wedge panel edges emanating from a common point, for each of the plurality of substrate-wedge panels, one of the wedge panel edges foldably connected to one of the side panel edges; and
a substantially waterproof coating adhered, the substantially waterproof coating forming a plurality of waterproof-coating-wedge panels between each substrate-wedge panel and adjacent side panel, wherein the waterproof-coating-wedge panels are substantially the same size as the substrate-wedge panels allowing the substrate-wedge panel to full pull the waterproof-coating-wedge panel between the substrate-wedge panel and the adjacent side panel, and wherein edges of adjacent side panels meet cleanly when the liner is inserted into the container.

2. The container liner of claim 1, wherein the container liner is adapted to a generally container-shaped configuration upon insertion into an animal container.

3. The container liner of claim 1, wherein the container liner is adapted to a generally container-shaped configuration upon insertion into a disposable container.

4. The container liner of claim 1, wherein the container liner is adapted to a generally container-shaped configuration upon insertion into a reusable container.

5. The container liner of claim 1, wherein the container liner assumes a generally flat configuration prior to use.

6. The container liner of claim 1, wherein the substrate is formed from paper.

7. The container liner of claim 1, wherein the substrate is formed from degradable plastics.

8. The container liner of claim 1, wherein the substantially waterproof coating is formed from degradable plastics.

9. The container liner of claim 1, wherein the substantially waterproof coating forms a sanitary barrier.

10. The container liner of claim 1, wherein the substantially waterproof coating is adhered by spraying adhesive on the substrate.

11. The container liner of claim 1, wherein the side panels comprise cutouts and the substantially waterproof coating forms a substantially waterproof window covering the cutouts.

12. The container liner of claim 1, wherein the substrate-wedge panel pulls the waterproof-coating-wedge panel flatly and fully between the substrate-wedge panel and the adjacent side panel when the liner is inserted into the container.

13. The container liner of claim 1, further comprising a foldable substrate structure adapted to assume a generally flat configuration prior to use and a generally open-enclosure-shaped configuration upon insertion into the container comprising:
a top panel with top panel edges;
structure-side panels foldably connected to one of the top panel edges; and
mounting tabs foldably connected to each of the structure-side panels, the mounting tabs adhered to the bottom panel covered with the substantially waterproof coating.

14. A method of providing a substantially waterproof container liner adapted to a generally container-shaped configuration upon insertion into a container, comprising:
providing a substrate comprising:
a bottom panel with a plurality of bottom panel edges;
a plurality of side panels foldably connected to each of the bottom panel edges, the side panels having side panel edges; and
a plurality of substrate-wedge panels with a pair of wedge panel edges emanating from a common point, for each of the plurality of substrate-wedge panels, one of the wedge panel edges foldably connected to one of the side panel edges;
and
adhering a substantially waterproof coating to the bottom panel, side panels, and substrate-wedge panels, the substantially waterproof coating forming a plurality of waterproof-coating-wedge panels between each of the substrate-wedge panel and adjacent side panel, wherein the waterproof-coating-wedge panels are substantially the same size as the substrate-wedge panels allowing the substrate-wedge panel to fully pull the waterproof-coating-wedge panel between the substrate-wedge panel and the adjacent side panel, and wherein edges of adjacent side panels meet cleanly when the liner is inserted into the container.

15. The method of claim 14, wherein the container liner is adapted to a generally container-shaped configuration upon insertion into an animal container.

16. The method of claim 14, wherein the container liner is adapted to a generally container-shaped configuration upon insertion into a disposable container.

17. The method of claim 14, wherein the container liner is adapted to a generally container-shaped configuration upon insertion into a reusable container.

18. The method of claim 14, wherein the container liner assumes a generally flat configuration prior to use.

19. The method of claim 14, wherein the substrate is formed from paper.

20. The method of claim 14, wherein the substrate is formed from degradable plastics.

21. The method of claim 14, wherein the substantially waterproof coating is formed from degradable plastics.

22. The method of claim 14, wherein the substantially waterproof coating forms a sanitary barrier.

23. The method of claim 14, wherein the step of adhering the substantially waterproof coating is accomplished by spraying adhesive on the substrate.

24. The method of claim 14, wherein the side panels comprise cutouts and the substantially waterproof coating forms a substantially waterproof window covering the cutouts.

25. The method of claim 14, wherein the substrate-wedge panel pulls the waterproof-coating-wedge panel flatly and fully between the substrate-wedge panel and the adjacent side panel when the liner is inserted into the container.

26. The method of claim 14, further providing a foldable substrate structure adapted to assume a generally flat configuration prior to use and a generally open-enclosure-shaped configuration upon insertion into the container comprising:
a top panel with top panel edges;
structure-side panels foldably connected to one of the top panel edges; and
mounting tabs foldably connected to each of the structure-side panels, the mounting tabs adhered to the bottom panel covered with the substantially waterproof coating.

27-39. (canceled)
